(19) United States
(12) Patent Application Publication
(10) Pub. No.: US 2009/0299410 A1
(43) Pub. Date: Dec. 3, 2009

(54) Sterling silver and/or metal gel and/or liquid centered teether

(76) Inventors: Lisa Ann Brabant, Stony Brook, NY (US); Erika Natalia Kuver-DelDuca, Tuckahoe, NY (US)

Correspondence Address: Lisa Ann Brabant, 5 Chittenden Avenue, Tuckahoe, NY, 10707, US

(21) Appl. No.: 12/156,291

(22) Filed: May 30, 2008

(51) Int. Cl. A61J 17/02

(52) U.S. Cl. 606/235

(57) ABSTRACT

The present invention is an infant teether or teething device with a hollow metal exterior, which may be comprised of, but shall not be limited to, sterling silver, aluminum or any other rust-resistant metal material and which may have a handle or portion of the exterior of the teether being composed of either metal covered by rubber, plastic, or a similar material or a handle composed solely of rubber, plastic, or a similar material to prevent the handle from becoming too cold. Inside the teether will be a liquid or gel that has the ability to remain cold for a prolonged time period following refrigeration or freezing. Said liquid or gel center may be comprised of, but shall not be limited to, water, food grade propalyne glycol, any other food grade, freezer-friendly gel or similar non-toxic material. The interior liquid or gel shall be enclosed in a sealed bag, expandable plastic material or other enclosed container capable of being frozen while holding a liquid and/or gel in order to prevent leakage.

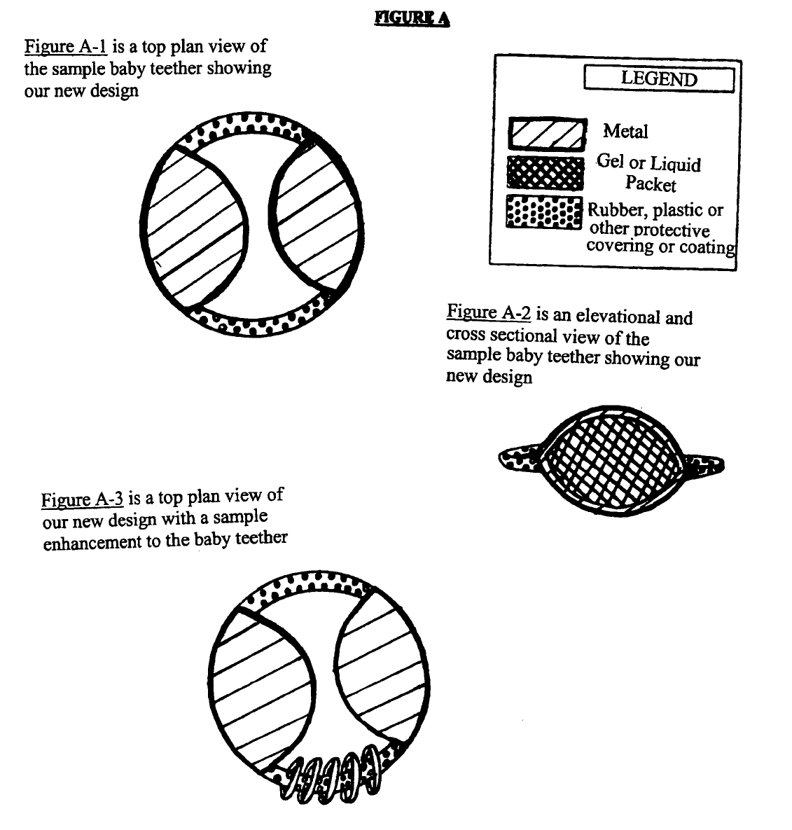

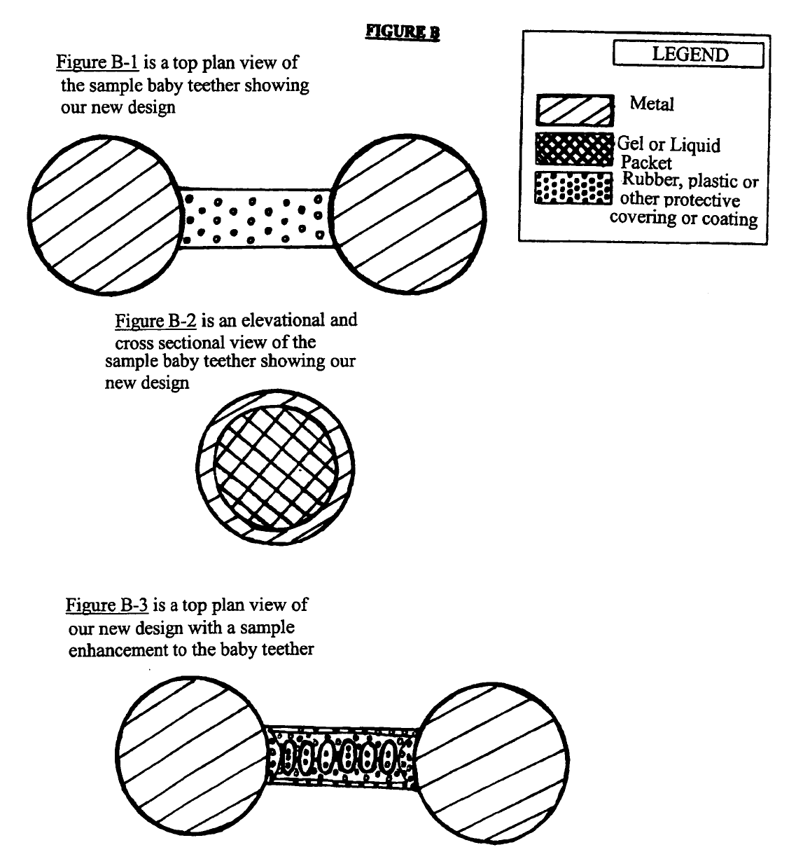

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

1. Field of Invention

This invention relates generally to infant care devices and more specifically to infant teethers.

2. Description of Prior Art

Teething is the eruption through the gums of baby teeth. Devices for soothing and quieting infants during the teething process are well known. Teethers, objects or devices for an infant to bite on during teething, in particular, have been commonly used for many years to soothe discomfort resulting from infant teething. Typical teethers consist of a rubber or soft plastic exterior, which may contain a freezable liquid that is refrigerated before use in order to numb an infant's gums and relieve teething pain.

Current teethers do not contain a metal exterior with a freezable liquid or gel center that will remain cold for an extended period of time following removal from refrigeration and/or after freezing, while providing a hard surface that will hasten the eruption of teeth through the gums. Thus there is a need for a device that accommodates an infant's desire for a cold, hard, smooth surface that will provide some relief from discomfort, hasten the eruption of the teeth from the gums and provide a distraction from the general discomfort associated with the teething process.

### BRIEF SUMMARY OF THE INVENTION

The present invention is an infant teether or teething device (“Teether”) with a hollow metal exterior, which may be comprised of, but shall not be limited to, sterling silver, aluminum or any other rust-resistant metal material and which may have a handle or portion of the exterior of the Teether being composed of either metal covered by rubber, plastic, or a similar material or a handle composed solely of rubber, plastic, or a similar material to prevent the handle from becoming too cold. The rubber, plastic, or similar material covering the metal and/or the handle of the Teether may be, but need not be, in multi-colored and/or multi-textured designs and patterns in order to stimulate infants, hold an infant's interest in the Teether and promote teething and soothing of the gums and teeth.

Inside the metal exterior of the Teether will be a liquid or gel that has the ability to remain cold for a prolonged time period following refrigeration or freezing. Said liquid or gel center may be comprised of, but shall not be limited to, water, food grade propalyne glycol, any other food grade, freezer-friendly gel or similar non-toxic material. The interior liquid or gel shall be enclosed in a sealed bag, expandable plastic material or other enclosed container capable of being frozen while holding a liquid and/or gel in order to prevent leakage (“Gel Packet”). The Gel Packet will lie within the hollow metal exterior. There may be, but need not be, multiple Gel Packets in any given Teether.

The Teether may also include a rattle, spinning mechanism or other enhancement in part of the device to hold an infant's attention. The Teether may be manufactured and produced in a variety of shapes and/or sizes (ring, barbell, decorative design or animal, etc.) in order to promote use by infants of varying ages and in order to stimulate infants and hold an infant's interest in the Teether.

The underlying objective of the design is to create a metal teether that will soothe an infant's gums, while stimulating the infant and holding their attention, and which will remain cold for an extended period of time following removal from refrigeration and/or after freezing thus prolonging the Teether's desired numbing effect while extending the timeframe in which it can be used. The combination of the hard, metal exterior with the freezable interior will soothe an infant's gums during the teething process while also assisting the teething process.

The details of one or more embodiments of the invention are set forth in the accompanying drawings and the description below. Other objectives, advantages, features and benefits of the present invention will be apparent from the description, taken together with the drawings, and from the claims that follow.

### BRIEF DESCRIPTION OF THE SEVERAL VIEWS OF THE DRAWINGS

FIG. A-1 is a top plan view of a sample infant teether showing our new design.

FIG. A-2 is an elevational and cross-sectional view of the sample infant teether.

FIG. A-3 is a top plan view of our new design with a sample enhancement to infant teether.

FIG. B-1 is a top plan view of a sample infant teether showing our new design.

FIG. B-2 is an elevational and cross-sectional view of the sample infant teether.

FIG. B-3 is a top plan view of our new design with a sample enhancement to infant teether.

### DETAILED DESCRIPTION OF THE INVENTION

Referring to the drawings, FIGS. A-1 and B-1 show a top plan view of a sample infant teether that includes a sterling silver, aluminum or other rust-resistant metal exterior with one or more handles composed of rubber, plastic or other similar material for an infant to hold. FIGS. A-2 and B-2 depict an elevational and cross-sectional view of the sample infant teether showing a freezable gel or liquid packet within the metal exterior. The metal exterior provides a cold, hard, smooth teething surface that will provide an infant with some relief from discomfort and hasten the eruption of teeth from the gums.

As shown in FIGS. A-3 and B-3, the infant teether may also include decorative elements secured to the handle in order to hold an infant's interest in the teether. For example, as shown in FIG. A-3, plastic rings can be attached to one of the teethers handles. FIG. B-3 shows a set of plastic beads attached to the handle that can be spun by an infant. Additionally, the handles of the infant teether may be in a variety of colors and/or different textured designs and patterns in order to further stimulate the gums of the teething infant and hold the infant's attention.

While the above description contains many specificities, these should not be construed as limitations on the scope of the invention, but rather as an example of the invention. Many other variations are possible.

For example, the exterior of the infant teether can be comprised of any metal that is rust-resistant and non-toxic. In addition, the gel or liquid packet contained in the hollow, metal exterior may be any gel, liquid and/or other fluid that is non-toxic. Many such fluids are conventionally available that have the freezing/refrigeration properties needed for this teether.

Additionally the size, shape, composition, color and texture of the infant teether may well vary and such variations are contemplated by the invention. An integral handle or carrying strap may also be added.

A number of embodiments of the invention have been described. Nevertheless, it will be understood that various modifications may be made without departing from the spirit and scope of the invention. Accordingly, other embodiments are within the scope of the following claims.

What is claimed is:

1. A teething device comprising: a hollow metal exterior, which may be comprised of, but shall not be limited to, sterling silver, aluminum or any other rust-resistant metal material; a handle or portion of the exterior of the teether being composed of either metal covered by rubber, plastic, or a similar material or a handle composed solely of rubber, plastic, or a similar material to prevent the handle from becoming too cold; and a liquid or gel center comprised of, but shall not be limited to, water, food grade propalyne glycol, any other food grade, freezer-friendly gel or similar non-toxic material that has the ability to remain cold for a prolonged period following refrigeration or freezing, which shall be enclosed in a sealed bag, expandable plastic material or other enclosed container capable of being frozen while holding a liquid and/or gel in order to prevent leakage.

2. The teething device of claim 1 wherein the metal exterior may be comprised of, but shall not be limited to, sterling silver, aluminum or any other rust-resistant metal material.

3. The teething device of claim 1 wherein the metal exterior contains a liquid or gel which may be comprised of, but shall not be limited to, water, food grade propalyne glycol, any other food grade, freezer-friendly gel or similar non-toxic material.

4. The teething device of claim 3 wherein the liquid or gel is enclosed in a sealed bag, expandable plastic material or other enclosed container capable of being frozen while holding a liquid and/or gel in order to prevent leakage.

5. The teething device of claim 1 wherein a handle or portion of the exterior of the teether may be composed of either metal covered by rubber, plastic, or a similar material or a handle composed solely of rubber, plastic, or a similar material to prevent the handle from becoming too cold.

6. The teething device of claim 5 wherein the rubber, plastic, or similar material covering the metal and/or the handle of the teether may be, but need not be, in multi-colored and/or multi-textured designs and patterns.

7. The teething device of claim 1 wherein the teether may also include a rattle, spinning mechanism or other enhancement in part of the device.

8. The teething device of claim 1 wherein the teether may be manufactured and produced in a variety of shapes and/or sizes (ring, barbell, decorative design or animal, etc.).
